(19) United States
(12) Patent Application Publication
(10) Pub. No.: US 2022/0387944 A1
(43) Pub. Date: Dec. 8, 2022

(54) PEANUT BUTTER STIRRER

(71) Applicant: Lifetime Brands, Inc., Garden City, NY (US)

(72) Inventors: Matthew KRUS, Seattle, WA (US); Ian MORGAN, Seattle, WA (US); Sami PIERCY, Seattle, WA (US)

(21) Appl. No.: 17/336,962

(22) Filed: Jun. 2, 2021

(51) Int. Cl. B01F 13/00; B01F 7/00; A47J 43/07; B01F 15/00

(52) U.S. Cl. CPC B01F 13/002; B01F 7/00575; A47J 43/0705; B01F 15/00506; B01F 7/002

(57) ABSTRACT

A stirring implement includes a stirrer having a single stir rod defining a generally triangular shape at a distal end thereof, a rotating guide defining a slot, wherein the single stir rod of the stirrer is inserted through the slot of the rotating guide such that the single stir rod is positioned at an angle with respect to a planar surface of the rotating guide, and a lid releasably engageable to the rotating guide. The stirrer has a handle at a proximal end thereof and the handle rotates circumferentially beyond an outer perimeter of the lid. An apex defined by the single stir rod travels circumferentially along an inner wall of an outer perimeter of a container attached to the lid.

### BACKGROUND

The present invention relates generally to stirring implements, and more specifically, to a peanut butter stirrer.

Natural peanut butter is free of hydrogenated oils and sugar. However, natural peanut butter is not easy to handle. Since natural peanut butter (basically peanuts and salt) doesn't use stabilizer oils to keep it homogenized, a person has to stir the peanut butter thoroughly when a jar is first opened. This may sound easy, however, if a person has attempted to mix or stir natural peanut butter, that person would claim that it's a cumbersome task to get it all mixed together smoothly. Additionally, during removal of any conventional stirring implement, e.g., a spoon, some of the oil and chunks of peanut butter always glob out on the countertop.

Therefore, consumers who prefer organic or all-natural nut butter must vigorously stir the contents of the jar each time it is used, which results in significant amounts of time and effort.

### SUMMARY

In accordance with an embodiment, a stirring implement is provided. The stirring implement includes a stirrer having a single stir rod defining a generally triangular shape at a distal end thereof, a rotating guide defining a slot, wherein the single stir rod of the stirrer is inserted through the slot of the rotating guide such that the single stir rod is positioned at an angle with respect to a planar surface of the rotating guide, and a lid releasably engageable to the rotating guide.

In accordance with another embodiment, a stirrer is provided. The stirrer includes a single stir rod defining a generally triangular shape at a distal end thereof and a handle positioned at a proximal end thereof.

In accordance with yet another embodiment, a stirring implement is provided. The stirring implement includes a wedge-shaped stir rod, a rotating guide defining a slot to receive the wedge-shaped stir rod therethrough, and a lid releasably engageable to the rotating guide.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 illustrates a perspective top view of a stirring implement, in accordance with an embodiment of the present invention;

FIG. 2 illustrates a perspective bottom view of the stirring implement of FIG. 1, in accordance with an embodiment of the present invention;

FIG. 3 illustrates a perspective side view of the stirring implement of FIG. 1 attached to a first container having a first height, in accordance with an embodiment of the present invention;

FIG. 4 illustrates a perspective side view of the stirring implement of FIG. 1 attached to a second container having a second height, in accordance with an embodiment of the present invention;

FIG. 5 illustrates an exploded perspective view of the stirring implement of FIG. 1, in accordance with an embodiment of the present invention;

FIG. 6 illustrates a cross-sectional view of the stirring implement of FIG. 1, in accordance with an embodiment of the present invention;

FIGS. 7A-7C illustrate the steps for attaching the lid of the stirring implement to a container, in accordance with an embodiment of the present invention; and

FIGS. 7D-7E illustrate the stirring operation and removal of the stirrer of the stirring implement from the container after sufficient stirring has been achieved, in accordance with an embodiment of the present invention.

Throughout the drawings, same or similar reference numerals represent the same or similar elements.

### DETAILED DESCRIPTION

Embodiments in accordance with the present invention provide for a stirring implement for stirring or mixing a substance, such as a high-viscosity substance within a container. The container can be, e.g., a peanut butter container and the high-viscosity substance can be, e.g., natural peanut butter.

The major difference between conventional and natural peanut butters shows up in the number and list of ingredients. For natural nut butters, products labeled with both “natural” and “butter” generally contain at least 90% peanuts with no artificial sweeteners, colors or preservatives. For conventional nut butters, conventional peanut butters can contain hydrogenated oils, sugar, salt and other ingredients such as soy protein, corn syrup and stabilizers. Truly natural peanut butters on the market contain just peanuts and salt.

Natural peanut butters require vigorous stirring since they aren't homogenized. Commercial brands offering a natural alternative generally contain an added stabilizer like palm oil. Palm oil takes the place of hydrogenated vegetable oil to help prevent separation of the oil and to maintain the creamier, spreadable texture. Nevertheless, although they contain 90% peanuts and loosely qualify as natural, they are stabilized with palm oil, which is outside of the definition for regular peanut butter.

Many people enjoy the taste of natural peanut butter. Natural peanut butter may separate out into its constituent ingredients (e.g., oil and solids), thus requiring re-mixing to be consumable. Standard kitchen appliances do not allow peanut butter lovers to re-mix peanut butter effectively and are often too heavy and/or bulky to use effectively or do not fit within the existing peanut butter container. The ability to thoroughly mix or stir peanut butter at home allows the consumer convenience and enables more complete usage of the peanut butter.

The exemplary embodiments of the present invention introduce a stirring implement to easily and effortlessly stir or mix a high-viscosity substance within a container. In one exemplary embodiment, the high-viscosity substance is natural peanut butter. The viscosity of a substance or fluid is a measure of its resistance to deformation at a given rate.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

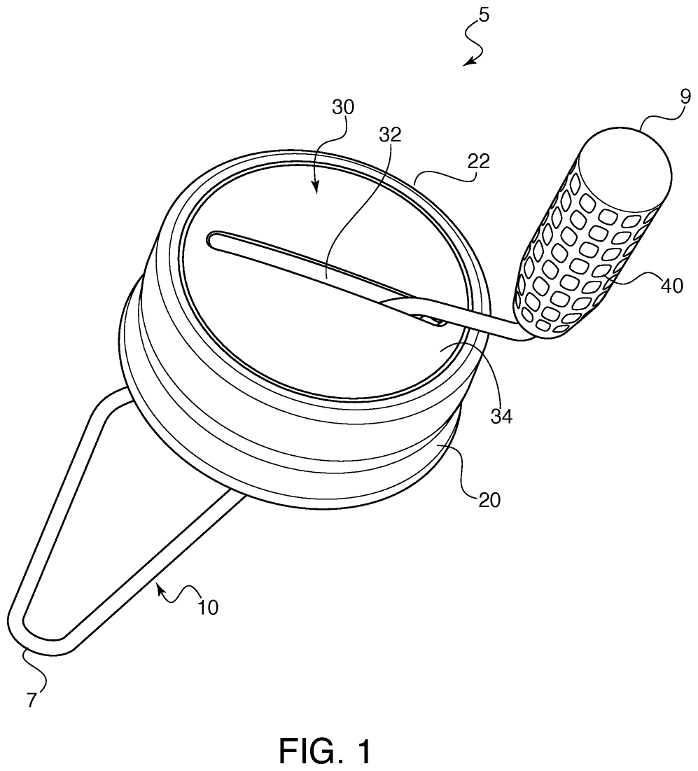

FIG. 1 illustrates a perspective top view of a stirring implement, in accordance with an embodiment of the present invention.

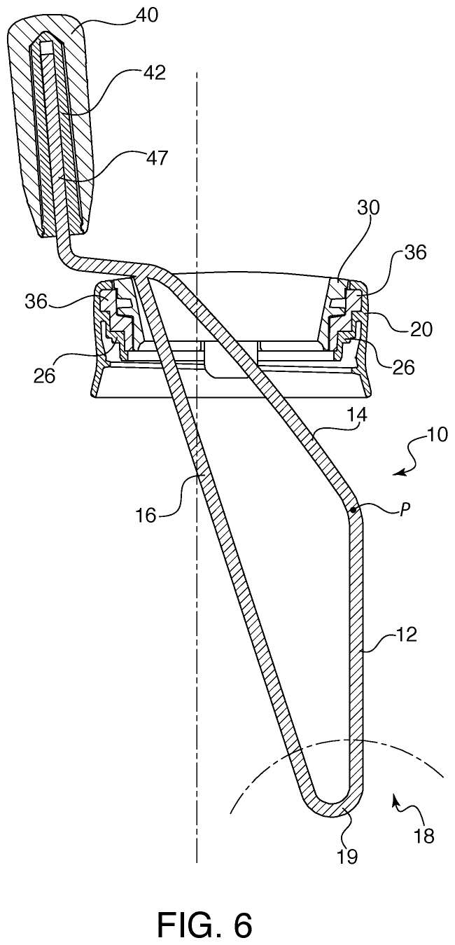

The stirring implement 5 includes three main components. The first component is a stirrer 45 (FIG. 5), the second component is a lid 20, and the third component is a rotating guide 30.

Regarding the first component, the stirrer 45 has a distal end 7 and a proximal end 9. The distal end 7 includes a single stir rod 10 being or constructed as a substantially or generally triangular shape. The shape of the stir rod 10 can also be referred to as an irregular shape or a boomerang-like shape or a wedge-like shape. The proximal end 9 of the stirrer 45 includes a handle 40, which is operated or actuated by a user's hand. Thus, this is a hand-operated mechanism for stirring or mixing substances within a container. The container can be, e.g., a food container. The container can also be referred to as a jar.

Regarding the second component, the lid 20 has a circular shape with an outer perimeter 22 and an opening 21 (FIG. 5) extending through the lid 20. The opening 21 is centrally disposed thereof (FIG. 5). The lid 20 can be made of any rigid material, including a sealant that is at least partially hardened, plastics including hydrophobic polymers, and the like. The lid 20 can further include a seal or rim ring 26 (FIG. 5). The seal 26 is rigidly affixed to the lid 20 during a manufacturing stage.

Regarding the third component, the rotating guide 30 is a circular component that defines a slot 32 on a top surface 34. Top surface 34 can be a planar surface. Tabs or fasteners or latches 36 (FIG. 5) extend along opposed side surfaces of the rotating guide 30. The tabs 36 can be, e.g., a pair of tabs dimensioned on diametrically opposed ends of the rotating guide 30. Of course, one skilled in the art can contemplate incorporating a different number of tabs, e.g., 3 tabs or 4 tabs or 5 tabs. Tabs 36 provide for secure engagement between the lid 20 and the rotating guide 30. In particular, the seal 26 of the lid 20 fixedly attaches to the tabs 36 of the rotating guide 30 to provide for secure engagement or operable cooperation between the lid 20 and the rotating guide 30.

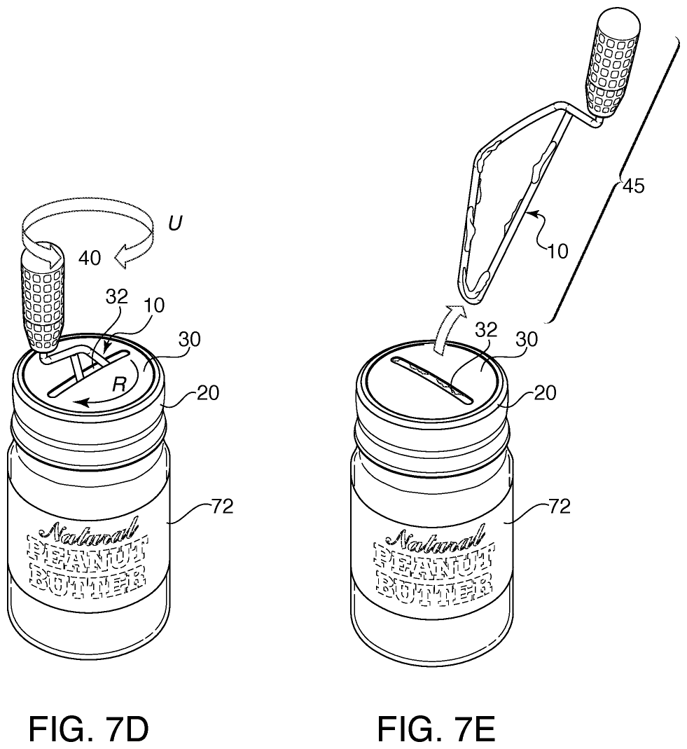

The rotating guide 30 rotates with the rotation of the handle 40. In other words, as a user or person rotates or swivels the handle 40, the rotating guide 30 rotates (in direction “R”; FIG. 7D) simultaneously or concurrently with the rotation of the handle 40. Stated differently, as the single stir rod 10 (defining a single loop that is angularly placed within a container) rotates or swivels to mix or stir a substance within the container, the rotating guide 30 also rotates in a same direction. It is noted that the lid 20 remains stationary or fixed as the rotating guide 30 rotates.

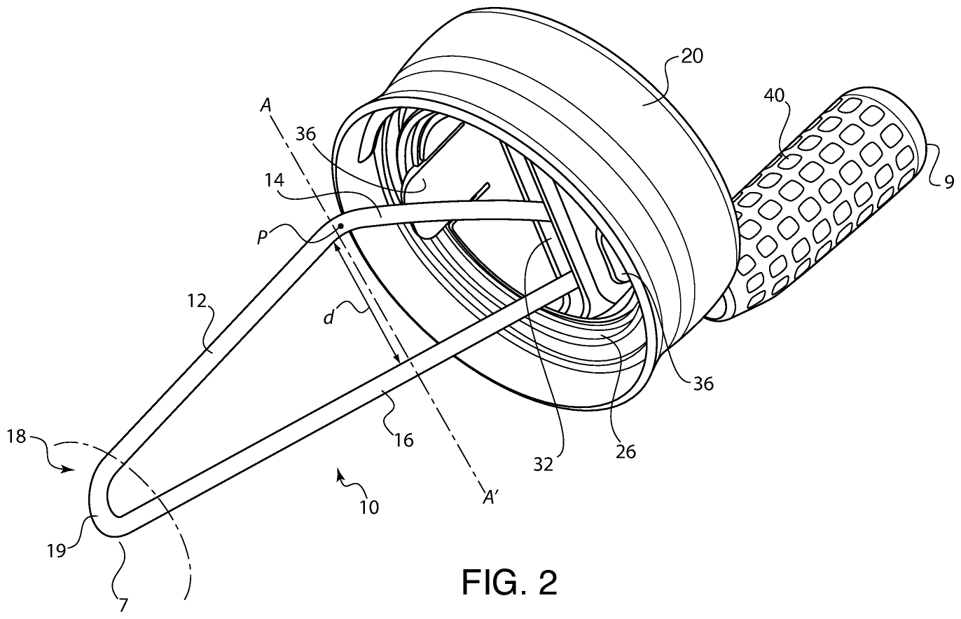

FIG. 2 illustrates a perspective bottom view of the stirring implement of FIG. 1, in accordance with an embodiment of the present invention.

The bottom view better depicts the distal end 7 of the stir rod 10, as well as the pair of tabs 36 of the rotating guide 30. The stir rod 10 is dimensioned to have a first leg 12, a second leg 14, and a third leg 16. The first, second, and third legs 12, 14, 16 can also be referred to as portions or sections or elements. A midpoint “P” indicates a separation point between the first leg 12 and the second leg 14. The midpoint “P” is dimensioned to be a distance “d” from the third leg 16. An axis A-A′ extends through the midpoint “P” to better visualize the lower section of the stir rod 10. The axis A-A′ defines a boundary between the lower section of the stir rod 10 and an upper section of the stir rod 10. The stir rod 10 is substantially or generally triangular or wedge shaped.

The distance “d” is smaller than a length of the slot 32 of the rotating guide 30. The distance “d” can be adjusted (during manufacturing) such that the third leg 16 is closer or farther away from the first and second legs 12, 14.

The distalmost area 18 (or outer end) of the first and third legs 12, 16 defines an apex 19.

The stir rod 10 is defined as a single stir rod. The single stir rod is one continuous and/or non-interrupted element. The single stir rod 10 is constructed from a single material and can be referred to as a homogenous element. In one instance, a starting point “S” of the single stir rod 10 can commence at the handle 40 and terminate at an ending point “E” at one end of the third leg 16 (FIG. 5). The single stir rod 10 can be welded at point “E.” The shape of the single stir rod 10 can be referred to as irregular or triangular shaped or wedge-shaped or boomerang-like. The single stir rod 10 is rigid or non-flexible. The single stir rod 10 is bladeless. The single stir rod 10 has a smooth outer surface throughout its length.

The stir rod 10 is configured to extend through or be received within slot 32 of the rotating guide 30. The tabs 36 of the rotating guide 30 are visible in the bottom perspective view. The tabs 36 cooperate or engage with the seal 26 of the of the lid 20. The rotating guide 30 is configured to be securedly fixed or attached to the central portion or opening 21 of the lid 20.

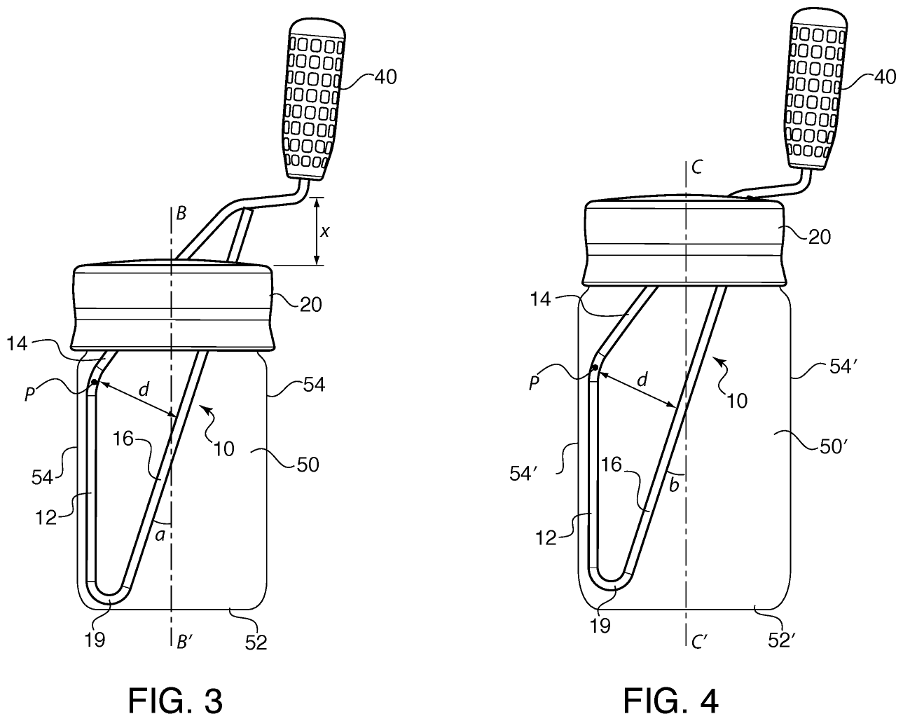

FIG. 3 illustrates a perspective side view of the stirring implement of FIG. 1 attached to a first container having a first height, in accordance with an embodiment of the present invention.

The stirring implement 5 is attached to a container 50 by placing the lid 20 over a top portion of the container 50. The lid 20 secures the stirring implement 5 to the container 50. The single stir rod 10 is placed through the slot 32 of the rotating guide 30 such that a majority of the single stir rod 10 is positioned within the container 50. Since this is a smaller container, a portion of the single stir rod 10 extends outside the container 50 and outside the confines of the lid 20. Distance “x” illustrates the portion of the single stir rod 10 that extends outside the confines of the lid 20.

Once the lid 20 is secured to the container 50, the handle 40 of the stirrer 45 (FIG. 5) extends beyond an outer perimeter of the lid 20 and the container 50. As explained below, the handle 40 is operated by a user, such that the handle 40 moves in a circular fashion to enable circular movement of the single stir rod 10 within the container 50.

The lid 20 is pressed onto the container 50. In other words, the lid 20 is attached to the container 50 without a swiveling or twisting or rotating motion. The lid 20 does not rotatably cooperate with the threads of the container 50. Stated differently, the outer surface of the lid 20 does not contain or define any threads that would cooperate with the threads of the container 50. Thus, lid 20 is not a twist lid, but a press-on style lid that securely fits over the threaded surface of the container 50.

The container 50 includes a bottom surface 52 and a side wall or side surface 54. An axis B-B′ is depicted that is perpendicular to the bottom surface 52 of the container 50. The axis B-B′ extends through the third leg 16 of the single stir rod 10, thus creating an angle “a” therebetween. The third leg 16 is at about a 45 degree angle with respect to axis B-B′. It is noted that the first leg 12 of the single stir rod 10 is parallel to the side surface 54 of the container 50.

The apex 19 is positioned adjacent the bottom surface 52 of the container 50. When the user or person turns or rotates or swivels the handle 40, the apex 19 travels circumferentially along the bottom surface 52 of the container 50. Thus, when the single stir rod 10 is positioned properly within the container 50, the apex 19 maintains a position adjacent the bottom surface 52 of the container 50 such that it consistently travels, in a circular or circumferential manner, along the inside of the outer perimeter of the container 50.

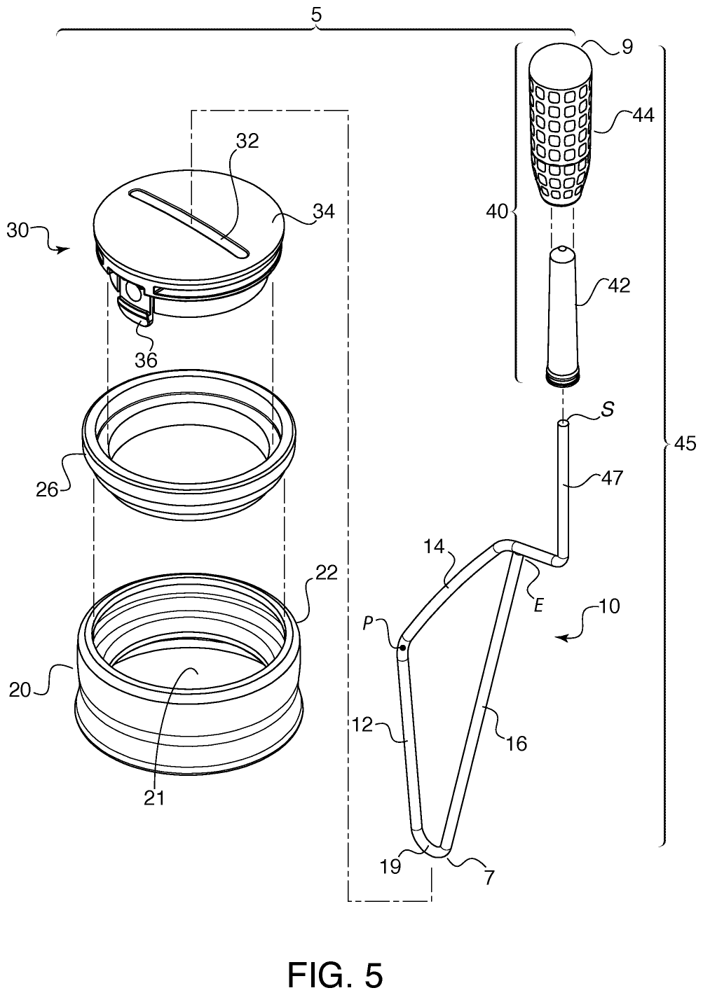

FIG. 4 illustrates a perspective side view of the stirring implement of FIG. 1 attached to a second container having a second height, in accordance with an embodiment of the present invention.

The stirring implement 5 is attached to a container 50′ by placing the lid 20 over a top portion of the container 50′. The lid 20 secures the stirring implement 5 to the container 50′. The single stir rod 10 is placed through the slot 32 of the rotating guide 30 such that the entirety of the third leg 16 of the single stir rod 10 is positioned within the container 50′. The container 50′ of FIG. 4 is larger than the container 50 of FIG. 3. As such, the entirety of the third leg 16 of the single stir rod 10 is accommodated within the confines of the container 50′ and the lid 20. Therefore, the same stirring implement 5 with the same stirrer 45 can be used on different sized containers. The lid 20 can accommodate a number of different sized containers, that is, containers of different heights.

Similarly to FIG. 3, once the lid 20 is secured to the container 50′, the handle 40 of the stirrer 45 extends beyond an outer perimeter of the lid 20 and the container 50′. As explained below, the handle 40 is operated by a user, such that the handle 40 moves in a circular fashion to enable circular movement of the single stir rod 10 within the container 50′.

The lid 20 is pressed onto the container 50′. In other words, the lid 20 is attached to the container 50′ without a swiveling or twisting or rotating motion. The lid 20 does not rotatably cooperate with the threads of the container 50′. Stated differently, the outer surface of the lid 20 does not contain or define any threads that would cooperate with the threads of the container 50′. Thus, lid 20 is not a twist lid, but a press-on style lid that securely fits over the threaded surface of the container 50′.

The container 50′ includes a bottom surface 52′ and a side wall or side surface 54′. An axis C-C′ is depicted that is perpendicular to the bottom surface 52′ of the container 50′. The axis C-C′ extends through the third leg 16 of the single stir rod 10, thus creating an angle “b” therebetween. The third leg 16 is at about a 45 degree angle with respect to axis C-C′. It is noted that the first leg 12 of the single stir rod 10 is parallel to the side surface 54′ of the container 50′.

The apex 19 is positioned adjacent the bottom surface 52′ of the container 50′. When the user turns or rotates or swivels the handle 40, the apex 19 travels circumferentially along the bottom surface 52′ of the container 50′. Thus, when the single stir rod 10 is positioned properly within the container 50′, the apex 19 maintains a position adjacent the bottom surface 52′ of the container 50′ such that it consistently travels, in a circular or circumferential manner, along the inside of the outer perimeter of the container 50′.

FIG. 5 illustrates an exploded view of the stirring implement of FIG. 1, in accordance with an embodiment of the present invention.

The exploded view clearly illustrates the three main components. The first component is the stirrer 45, the second component is the lid 20, and the third component is the rotating guide 30.

The stirrer 45 includes the handle 40 and the single stir rod 10.

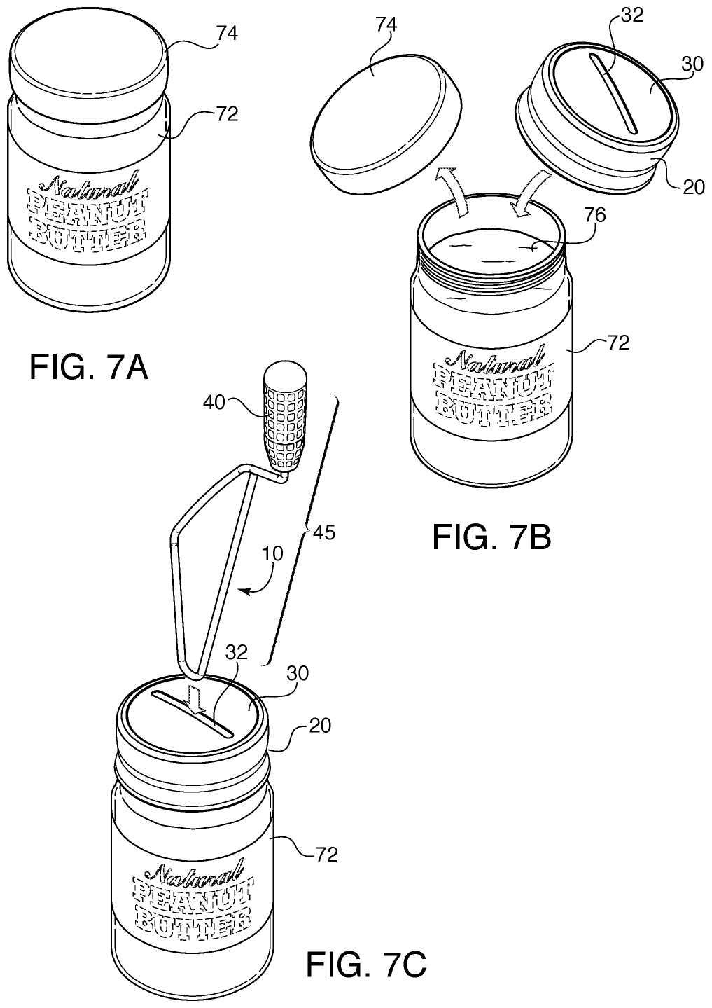

The handle 40 includes a handle core 42 and a rubber grip 44. The handle core 42 is received through the rubber grip 44 to form the handle 40. The handle core 42 is configured to receive a stir rod section 47 of the single stir rod 10. Thus, the stir rod section 47 of the single stir rod 10 is positioned within the handle 40 (FIG. 6). It is contemplated that the stir rod section 47 can extend an entire length of the handle 40.

As mentioned above, the single stir rod 10 has a first leg 12, a second leg 14, and a third leg 16. A midpoint “P” separates the first leg 12 from the second leg 14. The single stir rod 10 can have a starting point “S” and an ending point “E.” The distal end 7 of the single stir rod 10 defines an apex 19. The single stir rod 10 further defines a single loop via the first, second, and third legs 12, 14, 16.

The lid 20 has a central opening 21 and defines an outer perimeter 22. A seal 26 (or rim ring) is fixedly secured within the lid 20. The seal 26 enables the secure engagement between the lid 20 and the rotating guide 30.

The rotating guide 30 includes slot 32. Slot 32 can define an elongated line to facilitate insertion of the single stir rod 10 therethrough. Slot 32 extends a length of the top surface 34 of the rotating guide 30. The rotating guide 30 also includes a pair of tabs 36 (or fasteners or latches) to facilitate assembly or engagement between the rotating guide 30 and the lid 20.

FIG. 6 illustrates a cross-sectional view of the stirring implement of FIG. 1, in accordance with an embodiment of the present invention.

The cross-sectional view clearly illustrates the three main components, that is, the first component which is the stirrer 45, the second component which is the lid 20, and the third component which is the rotating guide 30. The cross-sectional view provides for a clearer illustration of the connection between the tabs 36 of the rotating guide 30 and the seal 26 of the lid 20. Additionally, the stir rod section 47 of the single stir rod 10 is shown extending into the handle core 42 and through a substantial length of the handle 40.

FIGS. 7A-7C illustrate the steps for attaching the lid of the stirring implement to a container, in accordance with an embodiment of the present invention.

FIG. 7A depicts a container 72 with a lid 74 attached thereon. The container includes, e.g., natural peanut butter 76. Of course, the container 72 can include any substance of varying viscosity.

FIG. 7B depicts the removal of the lid 74 and the attachment of the lid 20 having the rotating guide 30 with slot 32.

FIG. 7C depicts insertion of the single stir rod 10 of stirrer 45 through the slot 32 of the rotating guide 30.

FIGS. 7D-7E illustrate the stirring operation and removal of the stirrer of the stirring implement from the container after sufficient stirring has been achieved, in accordance with an embodiment of the present invention.

FIG. 7D depicts rotation “U” of the handle 40 to mix or stir the substance 76 in the container 72. The handle 40 can rotate in either a clockwise or counter clockwise direction.

It is noted that the rotating guide 30 rotates with the rotation of the handle 40. In other words, as the person rotates or swivels the handle 40, the rotating guide 30 rotates (in direction “R”) simultaneously or concurrently with the rotation of the handle 40. Stated differently, as the single stir rod 10 (defining a single loop that is angularly placed within the container 72) rotates or swivels to mix or stir the substance 76, the rotating guide 30 also rotates in a same direction (i.e., directions “U” and “R” point in the same direction). The rotating guide 30 rotates at the same speed as the handle 40. The lid 20 remains stationary or fixed as the rotating guide 30 rotates.

FIG. 7E depicts the removal of the stirrer 45 through the slot 32 of the rotating guide 30 after the user or person mixes or stirs the substance 76 to his/her satisfaction.

Therefore, in summary, a stirring implement is presented. The stirring implement includes three main components. The first component is a stirrer, the second component is a rotating guide, and the third component is a lid. The stirrer has a single stir rod attached to a handle. The rotating guide defines a slot to receive the single stir rod of the stirrer. A lid releasably engages the rotating guide. The lid is placed on containers of various sizes (e.g., different heights). The container includes substances with different viscosities. In one example, the substance is natural peanut butter. One skilled in the art can contemplate a variety of different substances, such as, but not limited to, cashew butter, almond butter, honey, maple syrup, jam, molasses, olive oil, etc. Moreover, the substance need not necessarily be a food substance. For example, the substance could be motor oil. The advantages of the present invention include at least the easy and convenient assembly and disassembly of the stirring implement, the successful stirring of substances of different viscosities within a container/jar, such as natural peanut butter, the prevention of spillage of big chunks of natural peanut butter or peanut butter oils during removal of such from the container/jar, and the prevention of waste of natural peanut butter residue stuck at the bottom of the container/jar. Another advantage of the present invention is that the same stirring implement with the same stirrer can be used on different sized containers. The lid can accommodate a number of different sized containers, that is, containers of different heights.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

1. A stirring implement comprising:
a stirrer having a single stir rod defining a generally triangular shape at a distal end thereof;
a rotating guide defining a slot, wherein the single stir rod of the stirrer is inserted through the slot of the rotating guide such that the single stir rod is positioned at an angle with respect to a planar surface of the rotating guide; and
a lid releasably engageable to the rotating guide.

2. The stirring implement of claim 1, wherein the lid is configured to be releasably engageable to a container having a substance therein to be mixed.

3. The stirring implement of claim 1, wherein the stirrer has a handle at a proximal end thereof.

4. The stirring implement of claim 3, wherein the handle of the stirrer circumferentially rotates beyond an outer perimeter of the lid.

5. The stirring implement of claim 1, wherein an apex defined by the single stir rod travels circumferentially along an inner wall of an outer perimeter of a container attached to the lid.

6. The stirring implement of claim 1, wherein the single stir rod is rigid and bladeless.

7. The stirring implement of claim 1, wherein the lid is releasably engageable to the rotating guide by a pair of tabs.

8. The stirring implement of claim 1, wherein the single stir rod has a first leg, a second leg, and a third leg.

9. The stirring implement of claim 8, wherein the first leg is perpendicular to a bottom portion of a container attached to the lid.

10. The stirring implement of claim 9, wherein the third leg is at about a 45 degree angle with respect to the bottom portion of the container.

11. The stirring implement of claim 8, wherein the single stir rod has a stir rod section, the stir rod section extending from the generally triangular shaped stir rod and into the handle.

12. A stirrer comprising:
a single stir rod defining a generally triangular shape at a distal end thereof; and
a handle positioned at a proximal end thereof.

13. The stirrer of claim 12, wherein the single stir rod is rigid.

14. The stirrer of claim 12, wherein the single stir rod is bladeless.

15. The stirrer of claim 12, wherein the single stir rod has a first leg, a second leg, and a third leg.

16. The stirrer of claim 15, wherein the single stir rod has a stir rod section, the stir rod section extending from the generally triangular shaped stir rod and into the handle.

17. A stirring implement comprising:
a wedge-shaped stir rod;
a rotating guide defining a slot to receive the wedge-shaped stir rod therethrough; and
a lid releasably engageable to the rotating guide.

18. The stirring implement of claim 17, wherein the wedge-shaped stir rod is rigid, bladeless, and angularly positioned within the container.

19. The stirring implement of claim 17, wherein an apex defined by the wedge-shaped stir rod travels circumferentially along an inner wall of an outer perimeter of a container attached to the lid.

20. The stirring implement of claim 19, wherein the lid is configured to be releasably engageable to a container having a substance therein to be mixed.
